(19) United States
(12) Patent Application Publication
(10) Pub. No.: US 2005/0075879 A1
(43) Pub. Date: Apr. 7, 2005

(54) Method of encoding text data to include enhanced speech data for use in a text to speech(tts)system, a method of decoding, a tts system and a mobile phone including said tts system

(76) Inventor: John Anderton, Livingston (GB)

Correspondence Address: Oliff & Berridge, PO Box 19928, Alexadria, VA, 22320, US

(21) Appl. No.: 10/482,187

(22) PCT Filed: Apr. 30, 2003
(86) PCT No.: PCT/GB03/01839

(30) Foreign Application Priority Data
May 1, 2002 (GB) 0209983.6

(51) Int. Cl. G10L 13/00

(52) U.S. Cl. 704/260

(57) ABSTRACT

A text to speech (TTS) system converts text to speech and involves determining the correct pronunciation. In addition to the correct pronunciation, many TTS systems control how the text is spoken by defining a particular speech mode. A speech mode may be defined as to at least the prosody, i.e. the speech rhythms, stresses on various words, changes in pitch, rate of speaking, changes in volume and how the text is spoken in terms of currency values, dates, times etc amongst other features. The present invention relates to a method for encoding enhanced speech data. The enhanced speech data is simple, easy to use, easy to learn, uses keyboard features already on the terminal device in which the TTS system is embedded and is independent of any of the markup languages or modifications applied when designing the TTS system in situ. Thus, the output text is customised to improve the quality of the speech and enables users to personalise their messages. The present invention thus relates to a method of encoding text data, decoding annotated text data, a TTS system and a mobile phone for implementing these.

The present invention relates to a method of encoding text data to include enhanced speech data for use in a text to speech (TTS) system, a method of decoding, a TTS system and a mobile phone including said TTS system.

A text to speech (TTS) system converts text to speech and involves determining the correct pronunciation. In addition to the correct pronunciation, many TTS systems control how the text is spoken by defining a particular speech mode. A speech mode may be defined as to at least the prosody, i.e. the speech rhythms, stresses on various words, changes in pitch, rate of speaking, changes in volume and how the text is spoken in terms of currency values, dates, times etc amongst other features. Hereinafter, text to be spoken together with such speech modes is referred to as text data.

The rising popularity of web based developments and the common use of markup languages, such as XML or HTML, to control the presentation of textual and/or graphic based information and to direct a human/computer dialogue using a display and computer keyboard and/or mouse input, has prompted the development of markup languages to control the presentation of audible information and to direct a human/computer dialogue using voice input (e.g. speech recognition) and voice output devices (e.g. text-to-speech or recorded audio). Such aural based markup languages include VoiceXML and one of its predecessors JSML (JAVA Speech Markup Language). Thus, it has been known in the prior art to define speech modes using markup languages. Examples of the use of such markup languages in presenting language data can be found in U.S. Pat. No. 6,088,675 or U.S. Pat. No. 6,269,336B.

A designer who incorporates a TTS system into an application can use markup languages to define the speech mode by using tags which can be assigned to all or parts of the input text. Alternatively the designer may choose to use the software programming interface provided by the TTS system (either a proprietary one or a more widely adopted interface such as Microsoft SAP I (www.microsoft.com/speech). Thus, defining a speech mode requires either expert level knowledge of the particular programming interface used by the TTS system or the markup language used. The expert level knowledge could be supported by access to tools for automatically generating the markup language. However, in either case, most users of TTS systems do not have such knowledge or such access to support tools.

It is an aim of the present invention to enhance the speech mode without requiring such expert level knowledge.

In U.S. Pat. No. 6,006,187, there is described an interactive graphical user interface for controlling the acoustical characteristics of a synthesised voice. However, this method requires a display and is rather cumbersome, particularly in connection with mobile devices such as mobile phones.

Accordingly, the present invention is directed to a method of encoding text data to include enhanced speech data for use in a text to speech (TTS) system, said method including:
adding an identifier to the text data to enable said enhanced speech data to be identified;
specifying enhanced speech data; and
adding said enhanced speech data to said text data; wherein the improvement lies in that said text data comprises text and initial speech data and said enhanced speech data improves the pronunciation of said text.

The present invention is also directed to a method of decoding annotated text data which includes enhanced speech data and text data for use in a text to speech (TTS) system, said method comprising:
detecting an identifier in the annotated text data to enable said enhanced speech data to be identified; and
separating said enhanced speech data from said text data; wherein the improvement lies in that said text data comprises text and initial speech data and said enhanced speech data improves the pronunciation of said text.

The present invention also includes a TTS system as defined in the attached claims.

Finally, the present invention also relates to a mobile telephone including a TTS system as defined in the attached claims.

Embodiments of the present invention will now be described by way of further example only and with reference to the accompanying drawings, in which:

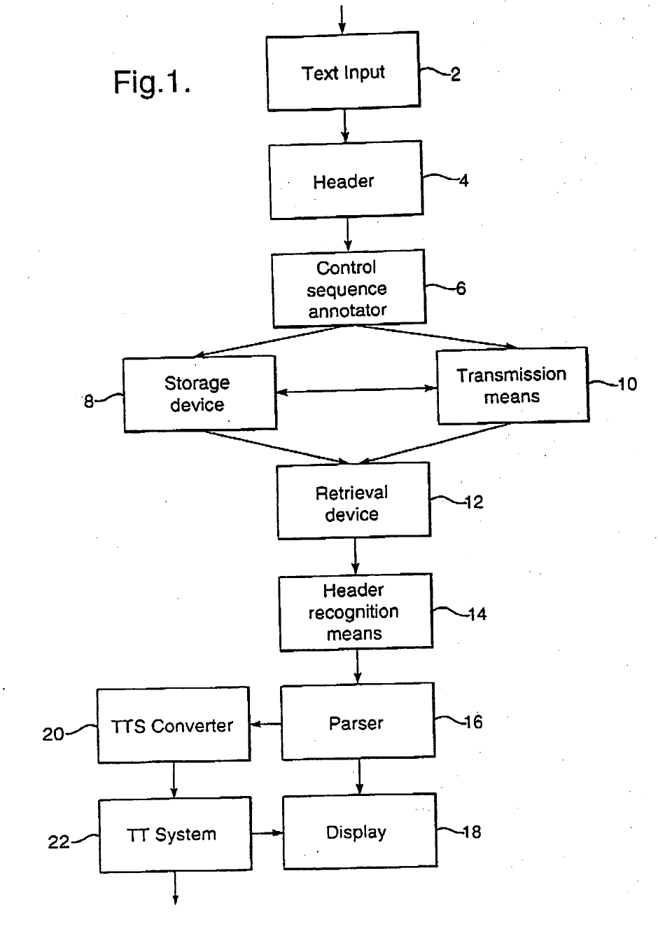

FIG. 1 is a diagram of the present invention;

FIG. 2 is a schematic view of a mobile telephone incorporating a TTS system according to the present invention;

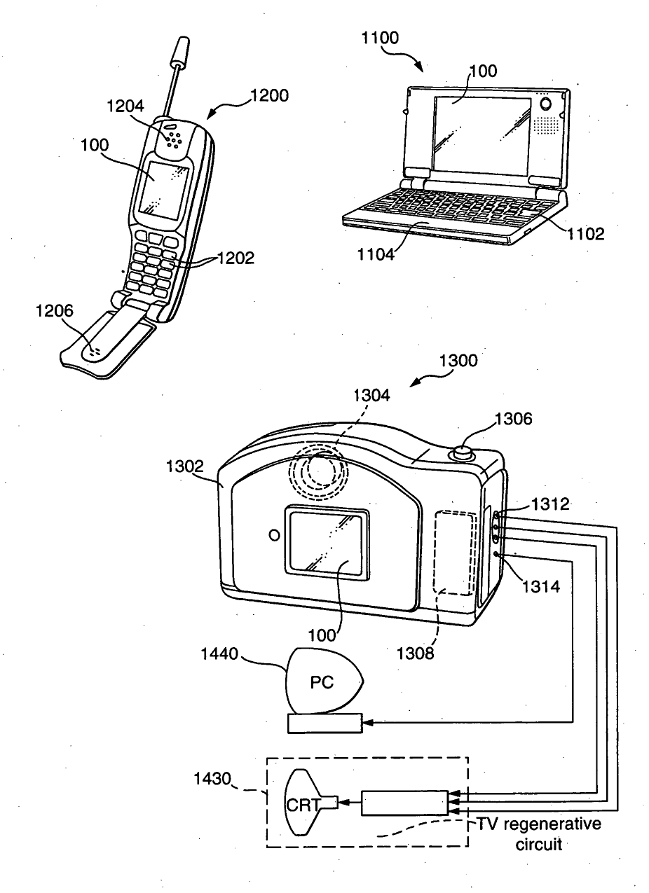

FIG. 3 is a schematic view of a mobile personal computer incorporating a TTS system according to the present invention; and

FIG. 4 is a schematic view of a digital camera incorporating a TTS system according to the present invention.

As shown in FIG. 1, text to be output as speech is first entered by an input device 2. This may comprise a user typing in text data or received by one of the applications in which the TTS system is embedded. For example, if the TTS system were embedded in a mobile phone, the text could be that received by the mobile phone by a caller or the mobile phone service provider. In the present invention, a header is added to flag to the TTS system that enhanced speech data is being added. The header is applied by a header 4.

The enhanced speech data is added to the text data in a control sequence annotator 6 to create annotated text data. Examples of such control sequences in enhanced speech data are given as follows:
\/ means low pitch
/\ means high pitch
<< means slow rate
>> means fast rate
/M means male voice
/F means female voice
## means whisper
.. means pause
_ means stressed word
/D means pronounce as a calendar date
/T means pronounce as a time
/S means spell out the word
/P means pronounce as a phone number.

As is clear from the above, the enhanced speech data is short, typically only 1 or 2 characters, generally less than 5 characters.

Thus, for example, the user could input the text “Hello George. Guess where I am? I'm in a bar. We need to set a date for a meeting. Say at 4 o'clock on the 23rd May. Thanks Jane” with enhanced speech data as follows:
“/F Hello George. Guess where /\I am? I'm in a ## bar. We need to set a date for a meeting. Say /T 4.00 on /D 23/05. Thanks Jane”.

The control sequences are all ones which can be found easily on most keyboards and in particular on the keypads of most mobile telephones and other devices with reduced keyboards, e.g. alarm control panels. The use of short sequences increases the likelihood of them being remembered by the user without reference to any explanatory texts. Moreover, the short sequences are easily distinguished from the initial speech data. Finally, the control sequences are also selected to minimise the likelihood of the control sequence being used naturally in the input text either text or initial speech data.

Some of the control sequences will be predetermined as open-ended. That is to say, all of the text following the control sequences will be subject to that particular enhanced speech. In the examples given above, \/, /\, <<, >>, /M, /F could all be predetermined to be open-ended. Some of the control sequences can be predetermined to be closed. That is to say, only the following word will be subject to that particular enhanced speech. In the examples given above, _, .., /D, /T could all be predetermined to be closed. In some cases, the control sequences could be either open-ended or closed and the user is able to add a control to indicate the extent of the control sequences being added. In the examples given above, ##, could be either open-ended or closed and the user can determine which is applied.

The enhanced speech data is simple, easy to use, easy to learn, uses keyboard features already on the terminal device in which the TTS system is embedded and is independent of any of the markup languages or modifications applied when designing the TTS system in situ. Thus, the output text is customised to improve the quality of the speech and enables users to personalise their messages.

The annotated text data, comprising the text data together with the enhanced speech data, being output by the control sequence annotator 6 may be stored within the same terminal device or application in which the TTS system is embedded in a storage device 8. If the annotated text data is stored, then the text can be spoken at a later date, in the case for example of an alert or appointment reminder message. In addition or alternatively, the annotated text data can be transmitted to another terminal device or application also containing a TTS system using a transmission means 10. The annotated text data could be stored by the receiving terminal device and/or output immediately.

The annotated text data will be received by a retrieval device 12 either later in time and/or following transmission from another terminal device. A header recognition means 14 detects whether a header has been added to the annotated text data. If a header is detected, then the annotated text data is passed to a parser 16.

The parser 16, identifies the control sequences and their position in the text data. The parser 16, separates the control sequences from the text data and outputs the text in a display 18. Simultaneously, the parser passes the text data and separated control sequences to a TTS converter 20. The TTS converter 20 obtains any attributes in the text data to determine the speech mode and converts the control sequences to modify the attributes and if need be dictate the speech mode. The TTS converter 20 passes the text and speech mode to the TTS system 22 in order for the TTS system to output the text as speech with the enhanced speech pronunciation.

The ability to add enhanced speech data is highly advantageous in applications where the text being spoken in subject to physical limitations. Such physical limitations may be as a result of the memory capacity used to store the text or the size of the text which is transmitted and received by the application in which the TTS system is embedded. Such limitations are often present in mobile phones. In the case of text being transmitted, sometimes, the transmission bandwidth is severely restricted. Such limited transmission bandwidth is very acute when using the GSM Short Message Service (SMS). Thus, the ability to add enhanced speech data will be particularly advantageous so as to maintain or improve speech quality without significantly affecting the size of the text.

Moreover, in view of the simplicity of the enhanced speech data, improved speech quality can be obtained without significantly slowing the output of text and is significantly faster then if such speech quality were provided by existing speech modes determined by the TTS system.

The present invention is advantageous for use in small, mobile electronic products such as mobile phones, personal digital assistants (PDA), computers, CD players, DVD players and the like—although it is not limited thereto.

Several terminal devices in which the TTS system is embedded will now be described.

1: Portable Phone

An example in which the TTS system is applied to a portable or mobile phone will be described. FIG. 2 is an isometric view illustrating the configuration of the portable phone. In the drawing, the portable phone 1200 is provided with a plurality of operation keys 1202, an ear piece 1204, a mouthpiece 1206, and a display panel 100. The mouthpiece 1206 or ear piece 1204 may be used for outputting speech.

2: Mobile Computer

An example in which the TTS system according to one of the above embodiments is applied to a mobile personal computer will now be described.

FIG. 3 is an isometric view illustrating the configuration of this personal computer. In the drawing, the personal computer 1100 is provided with a body 1104 including a keyboard 1102 and a display unit 1106. The TTS system may use the display unit 1106 or keyboard 1102 to provide the user interface according to the present invention, as described above.

3: Digital Still Camera

Next, a digital still camera using a TTS system will be described. FIG. 4 is an isometric view illustrating the configuration of the digital still camera and the connection to external devices in brief.

Typical cameras sensitise films based on optical images from objects, whereas the digital still camera 1300 generates imaging signals from the optical image of an object by photoelectric conversion using, for example, a charge coupled device (CCD). The digital still camera 1300 is provided with an OEL element 100 at the back face of a case 1302 to perform display based on the imaging signals from the CCD. Thus, the display panel 100 functions as a finder for displaying the object. A photo acceptance unit 1304 including optical lenses and the CCD is provided at the front side (behind in the drawing) of the case 1302. The TTS system may be embodied in the digital still camera.

Further examples of terminal devices, other than the portable phone shown in FIG. 2, the personal computer shown in FIG. 3, and the digital still camera shown in FIG. 4, include a personal digital assistant (PDA), television sets, view-finder-type and monitoring-type video tape recorders, car navigation systems, pagers, electronic notebooks, portable calculators, word processors, workstations, TV telephones, point-of-sales system (POS) terminals, and devices provided with touch panels. Of course, the TTS system of the present invention can be applied to any of these terminal devices.

The aforegoing description has been given by way of example only and it will be appreciated by a person skilled in the art that modifications can be made without departing from the scope of the present invention.

1. A method of encoding text data to include enhanced speech data for use in a text to speech (TTS) system, said method including:
adding an identifier to the text data to enable said enhanced speech data to be identified;
specifying enhanced speech data; and
adding said enhanced speech data to said text data; wherein the improvement lies in that said text data comprises text and initial speech data and said enhanced speech data improves the pronunciation of said text.

2. A method of encoding text data to include enhanced speech data for use in a text to speech (TTS) system as claimed in claim 1, further comprising storing said enhanced speech data and said text data.

3. A method of encoding text data to include enhanced speech data for use in a text to speech (TTS) system as claimed in claim 1, further comprising transmitting said enhanced speech data and said text data.

4. A method of encoding text data to include enhanced speech data for use in a text to speech (TTS) system as claimed in claim 1, in which said specifying said enhanced speech data includes specifying a number of control sequences which includes specifying at least one first control sequence to be open-ended thereby enabling all text to be subject to said first control sequence and/or at least one second control sequence to be closed thereby enabling the text associated with that second control sequence to be subject to that second control sequence and/or at least one third control sequence to be either open-ended or closed.

5. A method of decoding annotated text data which includes enhanced speech data and text data for use in a text to speech (TTS) system, said method comprising:
detecting an identifier in the annotated text data to enable said enhanced speech data to be identified; and
separating said enhanced speech data from said text data; wherein the improvement lies in that said text data comprises text and initial speech data and said enhanced speech data improves the pronunciation of said text.

6. A method of decoding annotated text data as claimed in claim 5, further comprising:
receiving said text data and storing said text data.

7. A method of decoding annotated text data as claimed in claim 5, further comprising:
displaying said text.

8. A text to speech (TTS) system for implementing to a method of encoding text data to include enhanced speech data, said method including:
adding an identifier to the text data to enable said enhanced speech data to be identified;
specifying enhanced speech data; and
adding said enhanced speech data to said text data; wherein the improvement lies in that said text data comprises text and initial speech data and said enhanced speech data improves the pronunciation of said text, and
a method of decoding annotated text data which includes enhanced speech data and text data, said method comprising:
detecting an identifier in the annotated text data to enable said enhanced speech data to be identified; and
separating said enhanced speech data from said text data; wherein the improvement lies in that said text data comprises text and initial speech data and said enhanced speech data improves the pronunciation of said text.

9. A TTS system as claimed in claim 8, including means for adding an identifier, a speech data annotator, means for detecting an identifier and a parser for separating the enhanced speech data from the text data.

10. A TTS system as claimed in claim 9, wherein said method of encoding text data to include enhanced speech data further comprises storing said enhanced speech data and said text data, said system further comprising a memory for storing said text data and said enhanced speech data.

11. A TTS system as claimed in claim 9, wherein said method of encoding text data to include enhanced speech data further comprises transmitting said enhanced speech data and said text data, said system further comprising transmission means for transmitting said text data and said enhanced speech data.

12. A mobile telephone including a text to speech system as claimed in claim 8.
